(19) United States
(12) Patent Application Publication
(10) Pub. No.: US 2008/0096054 A1
(43) Pub. Date: Apr. 24, 2008

(54) Magnetic recording medium and magnetic storage device

(75) Inventors: Jun Taguchi, Higashine (JP); Yuki Yoshida, Higashine (JP); Kazuhisa Shida, Higashine (JP); Noriyuki Asakura, Higashine (JP); Akira Kikuchi, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/704,880

(22) Filed: Feb. 9, 2007

(30) Foreign Application Priority Data
Oct. 24, 2006 (JP) 2006-289146

(51) Int. Cl. G11B 5/66

(52) U.S. Cl. 428/829

(57) ABSTRACT

A magnetic recording medium includes a substrate having a surface where a texture is formed along a recording direction; a first underlayer formed on the surface of the substrate and made of Cr or CrMn; a second underlayer formed on the first underlayer and made of CrMn; a third underlayer formed on the second underlayer and made of Cr—X1 alloy wherein X1 includes a material selected from the group consisting of Mo, Ti, W, V, Ta, and Nb; and a recording layer formed on the third underlayer and made of a ferromagnetic material whose main ingredient is Co; wherein content of Mn of the second underlayer is greater than content of Mn of the first underlayer if the first underlayer is made of CrMn; and a total of film thicknesses of the first underlayer and the second underlayer is in a range between 2 nm and 7 nm.

### BACKGROUND OF THE INVENTION

1. Field of the Invention

The present invention generally relates to magnetic recording media and magnetic storage devices, and more specifically, to a magnetic recording medium and a magnetic storage device used for an intra-surface magnetic recording method.

2. Description of the Related Art

Recently and continuingly, magnetic storage devices such as magnetic disk devices have been widely used as storage devices of digitized movies or music. Especially, the magnetic storage devices are used for video recording for home use. The magnetic storage device can realize high speed access, miniaturized size, and a large capacity. Hence, in replacing a conventional home video device using a video tape, the market size of the magnetic storage device is increasing. Since the video has a large amount of information, it is required for the magnetic disk device to have a large capacity. Because of this, in order to further improve the recording density that has increased 100% per year until now, it is necessary to improve techniques for higher recording densities of a magnetic head and the magnetic recording medium.

In order to realize higher recording densities, improvement of the magnetic recording medium, such as making magnetic particles of a recording layer fine or improvement of crystal orientation properties of the recording layer, is progressing.

In an intra-surface recording type magnetic recording medium, in order to realize higher recording densities, as improvement of the magnetic recording medium, a magnetic easy axis of the recording layer is oriented in a medium intra-surface well and the magnetic easy axis of the recording layer is oriented in a recording direction. See, for example, Japanese Laid-Open Patent Application Publication No. 2004-515027.

In the intra-surface recording type magnetic recording medium, the following means are used in order to make the magnetic easy axis of the recording layer orientate in the intra-surface of the magnetic recording medium and in the recording direction. That is, a texture formed by a polishing trace extending in a circumferential direction is formed on a surface of a disk-shaped substrate. In addition, an underlayer made of Cr film or Cr alloy film is formed on the texture and <110> crystal orientation of Cr is along the recording direction. On this layer, by using lattice matching with the underlayer, a c-axis that is a magnetic easy axis of Co of the recording layer is oriented in the circumferential direction.

Furthermore, for example, Japanese Laid-Open Patent Application Publication No. 2006-85888 discloses a method wherein a CrMn film is used as an underlayer so that orientation in the circumferential direction is improved.

However, since the orientation of the recording layer by the above-mentioned method is not sufficient, for further high density recording, the S/N ratio (signal-noise ratio) is decreased so that an error may easily occur and reproducing may be difficult.

### SUMMARY OF THE INVENTION

Accordingly, embodiments of the present invention may provide a novel and useful magnetic recording medium and magnetic storage device solving one or more of the problems discussed above.

More specifically, the embodiments of the present invention may provide a magnetic recording medium and a magnetic storage device wherein orientation of a magnetic easy axis of a recording layer is improved so that high density recording can be performed.

One aspect of the present invention may be to provide a magnetic recording medium, including a substrate having a surface where a texture is formed along a recording direction; a first underlayer formed on the surface of the substrate and made of Cr or CrMn; a second underlayer formed on the first underlayer and made of CrMn; a third underlayer formed on the second underlayer and made of Cr—X1 alloy wherein X1 includes a material selected from the group consisting of Mo, Ti, W, V, Ta, and Nb; and a recording layer formed on the third underlayer and made of a ferromagnetic material whose main ingredient is Co; wherein content of Mn of the second underlayer is greater than content of Mn of the first underlayer if the first underlayer is made of CrMn; and a total of film thicknesses of the first underlayer and the second underlayer is in a range between 2 nm and 7 nm.

According to the above-mentioned magnetic recording medium, the texture is formed on the surface of the substrate. The first underlayer is made of Cr or CrMn. The second underlayer is made of CrMn. The content of Mn of the second underlayer is greater than the content of Mn of the first underlayer. The third underlayer is made of Cr—X1 alloy. Therefore, it is possible to improve the recording orientation characteristics and the intra-surface orientation of the magnetic easy axis (c-axis) of the recording layer.

Especially, total film thickness of the first underlayer and the second underlayer is in a range between 2 nm and 7 nm. Hence, it can be assumed that the texture effectively improves the recording orientation characteristics and the intra-surface orientation of the magnetic easy axis (c-axis) of the recording layer and therefore the S/N ratio can be improved.

Another aspect of the present invention may be to provide a magnetic storage device, including a magnetic recording medium; and a recording and reproducing part having a recording element and a magneto-resistive effect type reproducing element; wherein the recording medium, including: a substrate having a surface where a texture is formed along a recording direction; a first underlayer formed on the surface of the substrate and made of Cr or CrMn; a second underlayer formed on the first underlayer and made of CrMn; a third underlayer formed on the second underlayer and made of Cr—X1 alloy wherein X1 includes a material selected from the group consisting of Mo, Ti, W, V, Ta, and Nb; and a recording layer formed on the third underlayer and made of a ferromagnetic material whose main ingredient is Co; wherein content of Mn of the second underlayer is greater than content of Mn of the first underlayer if the first underlayer is made of CrMn; and a total of film thicknesses of the first underlayer and the second underlayer is in a range between 2 nm and 7 nm.

According to the above-mentioned magnetic storage device, the recording orientation characteristics and the intra-surface orientation of the magnetic easy axis (c-axis) of the recording layer and the S/N ratio is good in the magnetic recording medium. Hence, it is possible to achieve the high density recording.

Thus, according to one or more embodiments of the present invention, it is possible to provide a magnetic recording medium and a magnetic storage device wherein orientation of a magnetic easy axis of a recording layer is improved so that high density recording can be performed.

Other objects, features, and advantages of the present invention will be come more apparent from the following detailed description when read in conjunction with the accompanying drawings.

### BRIEF DESCRIPTION OF THE DRAWINGS

FIG. 1 is a cross-sectional view of a magnetic recording medium of a first embodiment of the present invention;

FIG. 2 is a table showing characteristic properties of an example 1, an example 2, a comparison example 1, and a comparison example 2;

FIG. 3 is a graph showing relationship between the S/N ratio of a magnetic recording medium of an example 3 and film thicknesses of a first underlayer and a second underlayer;

FIG. 4 is a graph showing characteristic properties of intra-surface orientation of a magnetic recording medium of an example 4;

FIG. 5 is a graph showing characteristic properties of intra-surface orientation of a magnetic recording medium of a comparison example 3;

FIG. 6 is a table showing characteristic properties of an example 5 and a comparison example 4; and

FIG. 7 is a view showing a main part of a magnetic storage device of a second embodiment of the present invention.

### DETAILED DESCRIPTION OF THE PREFERRED EMBODIMENTS

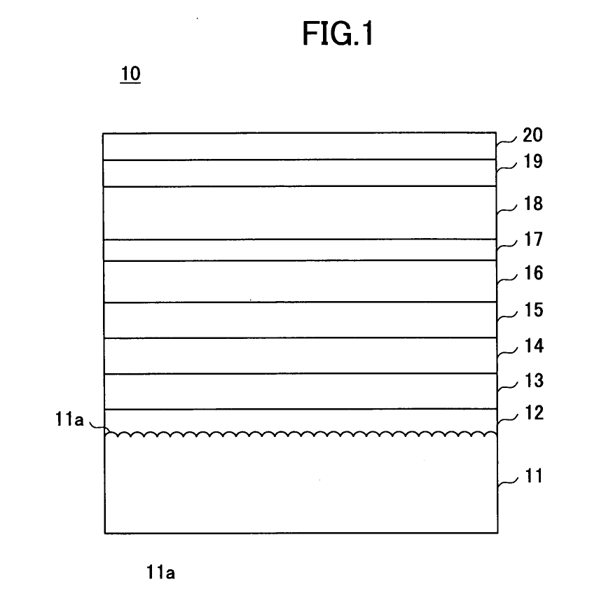

A description is given below, with reference to the FIG. 1 through FIG. 7 of embodiments of the present invention.

### 1. First Embodiment of the Present Invention

FIG. 1 is a cross-sectional view of a magnetic recording medium of a first embodiment of the present invention. As shown in FIG. 1, a magnetic recording medium 10 of the first embodiment of the present invention includes a substrate 11. On the substrate 11, a first underlayer 12, a second underlayer 13, a third underlayer 14, a fourth underlayer 15, a heat stabilization layer 16, a nonmagnetic coupling layer 17, a recording layer 18, a protection film 19 and a lubrication layer 20 are formed in this order. A texture 11a is formed on a substrate surface.

There is no limitation of a material of the substrate 11. For example, a glass substrate, an NiP plating aluminum alloy substrate, a silicon substrate, a plastic substrate, a ceramic substrate, a carbon substrate, or the like can be used as the substrate 11.

The texture 11a made by a large number of grooves formed along a recording direction (a circumferential direction in a case of the disk-shaped substrate) is formed on a surface of the substrate 11. The texture 11a, may be, for example, a mechanical texture or an ion beam texture. The mechanical texture is a polishing trace formed on a surface of the substrate by a polishing agent. The ion beam texture is a large number of grooves formed on the surface of the substrate.

The texture 11a satisfies the relationship 5<λ<40 nm wherein λ is defined as a distance between grooves in a direction perpendicular to the recording direction (a diameter direction in the case of the disk-shaped substrate). The texture 11a satisfies 0.5<φ<7 degrees wherein φ is defined as an inclination angle formed by a substrate surface (a virtual surface in a case where the texture 11a is not formed) and a virtual line connecting the groove and a top. An average groove depth (average value of a distance between a mountain and a groove of a cross section curve of the texture 11a) is between 0.3 nm and 0.8 nm. By forming such a texture, Cr <110> crystal orientation of the first through fourth underlayers 12 through 15 becomes good. In addition, the orientation is continued into the heat stabilization layer 16, the nonmagnetic coupling layer 17, and the recording layer 18 so that orientation in the recording direction of the magnetic easy axis (c-axis of cobalt (Co)) of the recording layer 18 becomes good.

The ion beam texture may be formed by a method discussed in Japanese Laid-Open Patent Application Publication No. 2006-172686.

The orientation in the recording direction is defined as an orientation degree in the recording direction. The orientation degree in the recording direction is expressed by a ratio of remanent magnetization film thickness product in the recording direction of the recording layer 18 and remanent magnetization film thickness product in a direction perpendicular to the recording direction, namely the following formula (1).

$$Orientation degree in the recording direction = ( Remanent magnetization film thickness product in the recording direction ) \div ( Remanent magnetization film thickness product in a direction perpendicular to the recording direction ) \qquad ( 1 )$$

In the case where the magnetic recording medium 10 is a magnetic disk, since the recording direction is a circumferential direction and a direction perpendicular to the recording direction is a diameter direction, a circumferential direction orientation degree indicating a circumferential orientation is expressed by the following formula (2).

$$Orientation degree in the circumferential direction = ( Remanent magnetization film thickness product in the circumferential direction ) \div ( Remanent magnetization film thickness product in the diameter direction ) \qquad ( 2 )$$

As the orientation degree in the recording direction or the orientation degree in the circumferential direction is larger in the above-mentioned formulas (1) and (2), the orientation degree in the recording direction or the orientation degree in the circumferential direction is good.

In a case of the substrate having a structure where a nonmagnetic metal layer is not formed on the surface of the substrate, such as a glass substrate, a silicon substrate, a plastic substrate, a ceramic substrate, or a carbon substrate, the texture 11a may be formed on the surface of a seed layer (not shown). The seed layer is formed by, for example, nonmagnetic NiP, CoW, CrTi or a ternary or more alloy whose main ingredient is an alloy of NiP, CoW, and CrTi (hereinafter “nonmagnetic seed layer material”).

In a case where the seed layer is made of an amorphous material such as NiP, it is preferable that an oxidation treatment be applied to its surface so that intra-surface orientation of the magnetic easy axis of the recording layer 18 is improved. The seed layer may be an alloy having a B2 crystal structure such as RuAl, NiAl or FeAl. An alloy film having the B2 crystal structure may be stacked on the above-mentioned nonmagnetic material seed layer film. In addition, the thickness of the seed layer is in a range of 5 nm through 30 nm, 5 nm through 15 nm preferably.

The first underlayer 12 is made of Cr or CrMn. In the first underlayer 12, due to influence of the texture 11a, Cr<110>crystal orientation is oriented along the recording direction. In addition, since the first underlayer 12 includes Cr, there is good adherence with the substrate 11.

Furthermore, in a case where the first underlayer 12 is made of CrMn, it is preferable that content of Mn be equal to or less than 35 atom %. If the content of Mn is greater than 35 atom %, disorder of the bcc structure of Cr is generated. In addition, it is preferable that the content of Mn be equal to or greater than 5 atom % so that orientation in the circumferential direction is improved.

Furthermore, it is preferable that the film thickness of the first underlayer 12 be equal to or greater than 0.5 nm and equal to or less than 5 nm. According to study of the inventors of the present invention, if the film thickness of the first underlayer 12 is greater than 5 nm, the S/N ratio of the magnetic recording medium may be decreased. If the film thickness of the first underlayer 12 is less than 0.5 nm, the structure of the first underlayer may be disorder and the desired effect may be degraded.

The second underlayer 13 is made of CrMn. Since the second underlayer 13 epitaxially grows on the first underlayer 12, Cr<110>crystal orientation is along the recording direction due to the influence of the crystal orientation of the first underlayer 12. The second underlayer 13 contains Mn so that the crystallization ability of the second underlayer 13 formed by sputtering becomes good and therefore the Cr<110>crystal orientation in the recording direction becomes better. As a result of this, via the layers 14 through 17 stacked thereon, orientation in the recording direction of the magnetic easy axis of the recording layer 18 becomes good.

In addition, it is preferable that the content of Mn in the second underlayer 13 be equal to or less than 35 atom %. If the content of Mn in the second underlayer 13 is greater than 35 atom %, the bcc structure of Cr may be disordered. In addition, it is preferable that the content of Mn be equal to or greater than 5 atom % so that orientation in the circumferential direction is improved.

The total of film thicknesses of the first underlayer 12 and the second underlayer 13 is in a range of 2 nm through 7 nm. According to study of the inventors of the present invention, it is found that the S/N ratio is good when the total of film thicknesses of the first underlayer 12 and the second underlayer 13 is in a range of 2 nm through 7 nm. In other words, it is found that the S/N ratio is decreased in a case where the total of film thicknesses of the first underlayer 12 and the second underlayer 13 is greater than 7 nm or less than 2 nm.

This may be because, in the first underlayer 12 and the second underlayer 13, corresponding to the configuration of the surface of the texture 11a, the crystal particles are grown in an oblique direction against a substrate surface, namely a virtual surface when the texture 11a is not formed. The crystal particles are in contact with each other by the heads so that internal stress is generated and the Cr<110>crystal orientation is in the texture direction. When the total of film thicknesses of the first underlayer 12 and the second underlayer 13 is greater than 7 nm, influence of the configuration of the surface of the texture 11a, namely influence of the distance λ between the grooves, the inclination angle φ, and the average groove depth, is degraded so that the Cr<110>crystal orientation is degraded. Because of this, the orientation in the recording direction of the magnetic easy axis of the recording layer 18 is degraded and therefore the S/N ratio is decreased.

In addition, when the total of film thicknesses of the first underlayer 12 and the second underlayer 13 is greater than 7 nm, the particle diameter of the crystal particle on the surface of the second underlayer 13 (the particle diameter on the cross section parallel with the substrate surface) is increased. This increase causes fleshiness of magnetic particles of the recording layer 18 and may secondarily cause degradation of the S/N ratio.

The third underlayer 14 and the fourth underlayer 15 are made of Cr—X1 alloy wherein X1 includes a material selected from the group consisting of Mo, Ti, W, V, Ta, and Nb. The third underlayer 14 or the fourth underlayer 15 includes an additional element selected from the group consisting of B, C, and Zr. The X1 element has an effect of widening a lattice gap of Cr and improving the lattice matching characteristic between the recording layer 18 and the heat stabilization layer 16 whose main ingredient is Co. In addition, by including the above-mentioned additional element, the crystal particles are refined so that the magnetic particles of the recording layer 18 are refined and the S/N ratio is improved.

As the third underlayer 14 and the fourth underlayer 15, CrMn including a material selected from the group consisting of B, C, and Zr may be used. The content of Mn is preferably equal to or less than 30 atom %.

It is preferable to form both the third underlayer 14 and the fourth underlayer 15 together from the view point of the S/N ratio. From the view point of simplification of a manufacturing process, the fourth underlayer 15 may be omitted.

The heat stabilization layer 16 is made of a ferromagnetic material whose main ingredient is Co. The heat stabilization layer 16 anti-ferromagnetically exchange-couples with the recording layer 18 via the nonmagnetic coupling layer 17. In a state where a magnetic field is not provided from outside, magnetization of the heat stabilization layer 16 and magnetization of the recording layer 18 are antiparallel. Content of Co of the heat stabilization layer 16 is equal to or greater than 50 atom %. The heat stabilization layer 16 is made of, for example, CoCr or CoCr-M1 alloy. M1 is a material selected from the group consisting of Pt, B, Ta, Ni, Cu, Ag, Pd, Si, C, Fe, Re, Nb, Hf, and an alloy of Pt, B, Ta, Ni, Cu, Ag, Pd, Si, C, Fe, Re, Nb, Hf, and an alloy of Pt, B, Ta, Ni, Cu, Ag, Pd, Si, C, Fe, Re, Nb, Hf. As a ferromagnetic material proper for the heat stabilization film 16, for example, CoCr, CoCrTa, CoCrTaB, CoCrPt, CoCrPtTa, CoCrPtB, or CoCrPtBCu may be used. From the view point of improvement of the crystal orientation of the recording layer 18, it is preferable that the heat stabilization film 16 be formed by stacking plural layers made of the above-mentioned ferromagnetic materials.

The nonmagnetic coupling layer 17 is selected from, for example, Ru, Rh, Ir, Ru group alloy, Rh group alloy, Ir group alloy, or the like. It is preferable that the nonmagnetic coupling layer 17 is made of Ru or Ru group alloy because the recording layer 18 formed on the nonmagnetic coupling layer 17 has a hcp (hexagonal close packed) structure. In addition, the thickness of the nonmagnetic coupling layer 17 is in a range between 0.4 nm and 1.2 nm. Since the thickness of the nonmagnetic coupling layer 17 is in a range between 0.4 nm and 1.2 nm, the heat stabilization film 16 and the recording layer 18 are anti-ferromagnetically exchange-coupled via the nonmagnetic coupling layer 17.

The recording layer 18 is made of ferromagnetic material whose main ingredient is Co. Content of Co of the recording layer 18 is equal to or greater than 50 atom %. The recording layer 18 is made of, for example, CoCr or CoCr-M1 alloy.

M1 is a material selected from the group consisting of Pt, B, Ta, Ni, Cu, Ag, Pd, Si, C, Fe, Re, Nb, Hf, and an alloy of Pt, B, Ta, Ni, Cu, Ag, Pd, Si, C, Fe, Re, Nb, Hf, and an alloy of Pt, B, Ta, Ni, Cu, Ag, Pd, Si, C, Fe, Re, Nb, Hf, and an alloy of Pt, B, Ta, Ni, Cu, Ag, Pd, Si, C, Fe, Re, Nb, and Hf. As a ferromagnetic material proper for the recording layer 18, for example, CoCrPt, CoCrPtTa, CoCrPtB, or CoCrPtBCu may be used. For avoiding increase of the particle diameter of the magnetic particles, it is preferable that the recording layer 18 be formed by stacking plural layers made of the above-mentioned ferromagnetic materials.

On the relationship between the heat stabilization layer 16 and the recording layer 18, it is preferable that a product of the remanent magnification and the film thickness, namely the relationship of the remanent magnetization film thickness product satisfies the following inequality.

Mr₁×t₁<Mr₂×t₂

In the above-mentioned inequality, Mr₁ and Mr₂ denote remanent magnetization of the heat stabilization layer 16 and the recording layer 18, and t₁ and t₂ denote thickness of the heat stabilization layer 16 and the recording layer 18, respectively. By satisfying the above-mentioned relationship, the magnetic recording medium 10 substantially has a remanent magnetization film thickness product having a size of “Mr₂×t₂−Mr₁×t₁” and has remanent magnetization in the same direction as the remanent magnetization of the recording layer 18. It is preferable that a substantial size of the remanent magnetization film thickness product “Mr₂×t₂−Mr₁×t₁” be in a range between 2.0 nTm through 10.0 nTm.

The ferromagnetic material forming the recording layer 18 may be different from the ferromagnetic material forming the heat stabilization layer 16. For example, the ferromagnetic material forming the recording layer 18 is selected from materials having anisotropic magnetic fields greater than that of the ferromagnetic material forming the heat stabilization layer 16. For selecting such a ferromagnetic material, a ferromagnetic material not containing Pt is used for the heat stabilization layer 16 and a ferromagnetic material containing Pt is used for the recording layer 18. Alternatively, a ferromagnetic material having a Pt density (as an atomic percentage) greater than a Pt density of a ferromagnetic material forming the heat stabilization layer 16 is used as a material of the recording layer 18.

Thus, the heat stabilization film 16 and the recording layer 18 are anti-ferromagnetically exchange-coupled via the nonmagnetic coupling layer 17. Therefore, a substantial volume of remanent magnetization formed by recording is the sum of exchange-coupled heat stabilization film 16 and recording layer 18. Hence, the substantial volume of the remanent magnetization is increased more as compared to a case where the heat stabilization film 16 is not provided so that V of KuV/kt that is an index of thermal decay resistance is increased so that the thermal decay resistance is increased. Here, K denotes an uniaxial anisotropy constant, V denotes a sum of volumes of magnetic particles of the heat stabilization film 16 and the recording layer 18 giving an exchange interaction to each other, k denotes Boltzmann's constant, and T denotes temperature. The recording layer 18 is not limited to a single layer. The recording layer 18 may be formed by stacking plural layers.

The protection film 19 has thickness in a range between 0.5 nm through 10 nm, 0.5 nm and 5 nm preferably. The protection film 19 may be made of, for example, diamond-like carbon, nitride carbon, or amorphous carbon.

The lubrication layer 20 is made of an organic group liquid lubricant where, for example, PFPE (perfluoropolyether) is a main chain and “—OH”, phenyl group, or the like is an end group. Depending on the kind of the protection film 20, the lubrication layer 21 may be or may not be provided.

Thus, as discussed above, according to the magnetic recording medium 10 of the first embodiment of the present invention, the texture 11a is formed on the surface of the substrate 11. The first underlayer 12 is made of Cr or CrMn. The second underlayer 13 is made of CrMn. The content of Mn of the second underlayer 13 is greater than the content of Mn of the first underlayer 12. The third underlayer 14 is made of Cr—X1 alloy. Therefore, it is possible to improve the recording orientation characteristics and the intra-surface orientation of the magnetic easy axis (c-axis) of the recording layer 18.

Especially, the total of film thicknesses of the first underlayer 12 and the second underlayer 13 is in a range between 2 nm and 7 nm. Hence, it can be assumed that the texture effectively improves the recording orientation characteristics and the intra-surface orientation of the magnetic easy axis (c-axis) of the recording layer 18 and therefore the S/N ratio can be improved.

In addition, the fourth underlayer 15 made of Cr—X1 alloy is provided on the third underlayer 14 and the third underlayer or the fourth underlayer further includes the additional element selected from the group consisting of B, C, and Zr. Hence, it is possible to refine the magnetic particles of the magnetic layer 18 by refining of the crystal particles so that the S/N ratio can be further improved.

While it is preferable that the heat stabilization layer 16 and the non-magnetic coupling layer 17 be formed, these two layers are not required when the thermal decay resistance can be secured.

Next, a manufacturing method of the magnetic recording medium 10 of the first embodiment of the present invention is discussed with reference to FIG. 1.

First, the texture 11a is formed on the surface of the disk-shaped substrate 11 by a mechanical texturing method. More specifically, while the substrate 11 is rotated and slurry liquid of polishing powder is supplied, the surface of the substrate is pressed by a fabric, so that the texture 11a formed by a large number of polishing traces is formed in a circumferential direction on the surface of the substrate. As discussed above, the texture may be formed after the seed layer is formed on the surface of the substrate 11 by sputtering. The texture may be formed on the surface of the substrate 11 by an ion beam method.

Next, the substrate 11 where the texture 11a is formed is heated in a vacuum state at, for example, 190° C. Then, by a DC (direct current) magnetron sputtering method using a sputtering target made of the above-mentioned material, the first underlayer 12, the second underlayer 13, the third underlayer 14, and the fourth underlayer 15 are formed in this order in, for example, an Ar environment (for example at pressure of 0.67 Pa). When the second underlayer 13 is formed, a direct current bias of a negative voltage may be applied. By applying the bias, the crystallinity of the second underlayer 13 is further improved so that the orientation of the recording direction (circumferential direction) of Cr<110>crystal orientation is improved. In addition, when the first underlayer 12, the third underlayer 14, and the fourth underlayer 15 are formed, a direct current bias of a negative voltage may be applied.

After that, by the DC (direct current) magnetron sputtering method using a sputtering target made of the above-mentioned material, the heat stabilization layer 16, the nonmagnetic coupling layer 17, and the recording layer 18 are formed on the fourth underlayer 15 in this order. The substrate 11 may be heated at 190° C. before the heat stabilization layer 16 and the nonmagnetic coupling layer 17 are formed.

Next, the protection film 19 made of carbon is formed on the recording layer 18 by using a sputtering method, CVD (chemical vapor deposition) method, FCA (Filtered Cathodic Arc) method, or the like. From a step forming the first underlayer 12 to a step forming the protection film 19, it is preferable that during the interval between the steps the substrate 11 be kept in a vacuum or inactive gas environment. Because of this, it is possible to maintain the surfaces of the deposited layers clean.

Next, the lubrication layer 20 is formed on the surface of the protection film 19. The lubrication layer 20 is formed by applying dilution where the lubricant is diluted by a solvent by a soaking method or spin coating method.

By the above-discussed steps, the magnetic recording medium 10 of the first embodiment of the present invention is formed.

In a case where the substrate 11 is tape-shaped, the same processes other than a step forming the texture can be used for forming the magnetic recording medium 10 of the first embodiment of the present invention. While the tape-shaped substrate 11 is moved in a longitudinal direction and slurry liquid of polishing powder is supplied, the surface of the substrate is pressed by fabric, so that the texture 11a can be formed.

Next, examples of the first embodiment of the present invention are discussed. An atom % is used in the following description regarding composition.

### EXAMPLE 1

The structure of the magnetic recording medium of Example 1 is the same as the structure shown in FIG. 1. A texture of polishing trace is formed on a disk-shaped NiP plating aluminum alloy substrate in a circumferential state by the mechanical texturing method.

Next, the substrate where the texture is formed is heated in the vacuum state at 240° C. and a Cr film having film thickness of 1 nm, a CrMn₁₀ film having film thickness of 3 nm, a CrMo₂₀B₅ film having film thickness of 1 nm, and a CrMn₃₀ film having film thickness of 20 nm are formed in this order as the first through fourth underlayers in the Ar environment by the DC magnetron sputtering.

Next, as the heat stabilization layer, the nonmagnetic coupling layer, and the recording layer, a CoCr₂₀ film having film thickness of 2 nm, a Ru film having film thickness of 1 nm, and a recording layer CoCrPtB layer having film thickness of 15 nm are deposited in the Ar environment by the DC magnetron sputtering. In addition, a diamondlike carbon film having film thickness of 4 nm is deposited as the cover film by the CVD method and the lubrication layer having film thickness of 1 nm is formed by a lifting method. Thus, the magnetic recording medium of the first example is formed.

### EXAMPLE 2

In a magnetic recording medium of the Example 2, the same conditions are applied as in the Example 1, other than that the film thickness of the second underlayer CrMn₁₀ film is 2 nm and the film thickness of the third underlayer CrMn₂₀B₅ film is 2 nm.

### COMPARISON EXAMPLE 1

In a magnetic recording medium of the comparison example 1, the same conditions are applied as the Example 1, other than that the film thickness of the first underlayer Cr film is 4 nm and the second underlayer is omitted.

### COMPARISON EXAMPLE 2

In a magnetic recording medium of the comparison example 2, the same conditions are applied as the Example 1, other than that the first underlayer is omitted and the film thickness of the second underlayer CrMn₁₀ film is 4 nm.

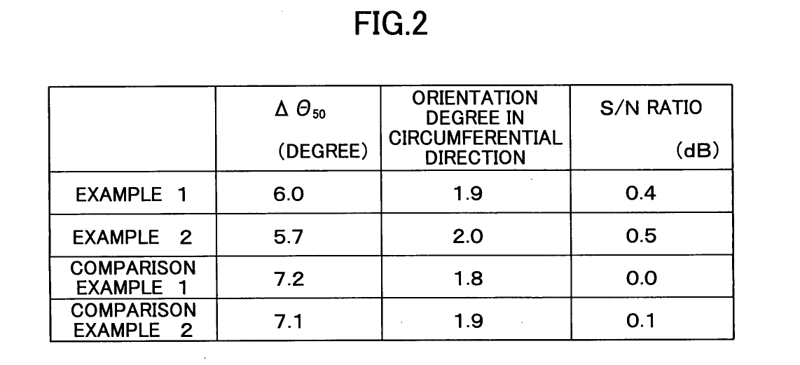

FIG. 2 is a table showing characteristic properties of the example 1, the example 2, the comparison example 1, and the comparison example 2. Δθ₅₀ in FIG. 2 indicates a locking curve in a peak position corresponding to a Co(1120)crystal surface measured by using an X ray diffraction device. As the value of Δθ₅₀ is smaller, intra-surface orientation of the C-axis (magnetic easy axis) of the recording layer CoCrPtB is better. In addition, an orientation degree in a circumferential direction is obtained by measuring the remanent magnetization film thickness product in the circumferential direction and the diameter direction by a VSM (Vibrating Sample Magnetometer) and calculating by the above-mentioned formula (2).

The S/N ratio is obtained by using a spin stand type recording and reproducing characteristic measuring device and a GMR type magnetic head where the reproducing element is a spin valve. The S/N ratio of other magnetic recording media are indicated where the S/N ratio of the comparison example 1 is a standard under the conditions of a measuring radial position of 20 mm, the disk rotational speed of 10025 rpm, and a track recording density of 385 kFCI.

Referring to FIG. 2, Δθ₅₀ of the Example 1 and the Example 2 are smaller than Δθ₅₀ of the comparison example 1 and the comparison example 2 and intra-surface orientation of the magnetic easy axis of the recording layer is improved. In addition, the orientation degrees in the circumferential direction of the Example 1 and the Example 2 are substantially the same as those of the comparison example 1 and the comparison example 2. Furthermore, the S/N ratios of the Example 1 and the Example 2 are higher than the S/N ratios of the comparison example 1 and the comparison example 2. Thus, the intra-surface orientation of the magnetic easy axis of the recording layer is increased and the S/N ratio is improved by simultaneously using the first underlayer Cr film and the second underlayer CrMn₁₀ film. In addition, the intra-surface orientation and the S/N ratio of the Example 2 are better than these of the Example 1. By adding Mn to the third underlayer, the intra-surface orientation and the S/N ratio are further improved.

### EXAMPLE 3

A magnetic recording medium of the Example 3 has the same structure as that of the Example 1 other than that the film thicknesses of the first underlayer Cr film and the second underlayer CrMn₁₀ film are different from those of the Example 1. Forming conditions of the Example 3 are the same as those of the Example 1.

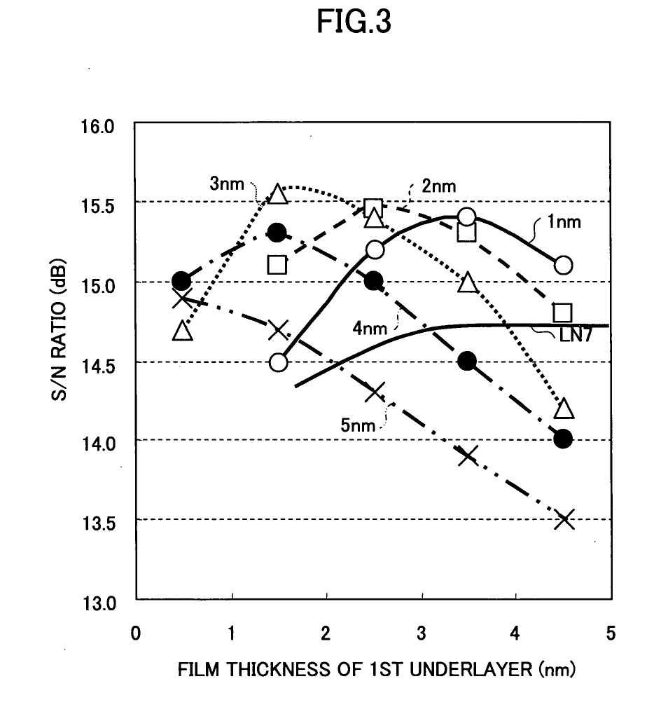

FIG. 3 is a graph showing relationship between the S/N ratio of the magnetic recording medium of the example 3 and film thicknesses of the first underlayer and the second underlayer. In FIG. 3, ◯ denotes a case where the film thickness of the second underlayer is 1 nm; □ denotes a case where the film thickness of the second underlayer is 2 nm; Δ denotes a case where the film thickness of the second underlayer is 3 nm; denotes a case where the film thickness of the second underlayer is 4 nm; and X denotes a case where the film thickness of the second underlayer is 5 nm. A solid line indicated by LN7 is a line where the total sum of the film thicknesses of the first underlayer and the second underlayer is 7 nm.

Referring to FIG. 3, each of curve lines has an upward convex configuration. In the case where the film thickness of the first underlayer is equal to or greater than 4 nm, the S/N ratio is decreased as the film thickness of the first underlayer is increased. Especially, the S/N ratio is decreased at a side where the film thickness of the first underlayer is increased more than the solid line indicated by LN7. That is, the film thickness of the first underlayer is equal to or less than 7 nm.

### EXAMPLE 4

The same structure and forming conditions of the Example 1 are applied to a magnetic recording medium of the Example 4. In the Example 4, the film thickness of the second layer CrMn film is 3 nm and the content of Mn is changed from 0 atom % to 20 atom % every 5 atom %. A case where the content of Mn is 0 atom % is not related to the present invention and is indicated for the comparison purpose.

### COMPARISON 3

The same structure and forming conditions of the comparison example 2 are applied to a magnetic recording medium of a comparison example 3. In the comparison example 3, the film thickness of the second layer CrMn film is 4 nm and the content of Mn is changed from 0 atom % to 15 atom % every 5 atom %.

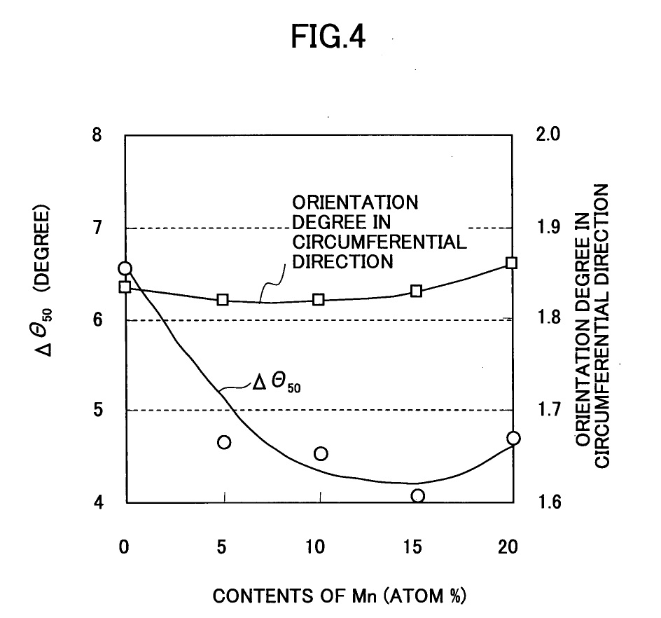

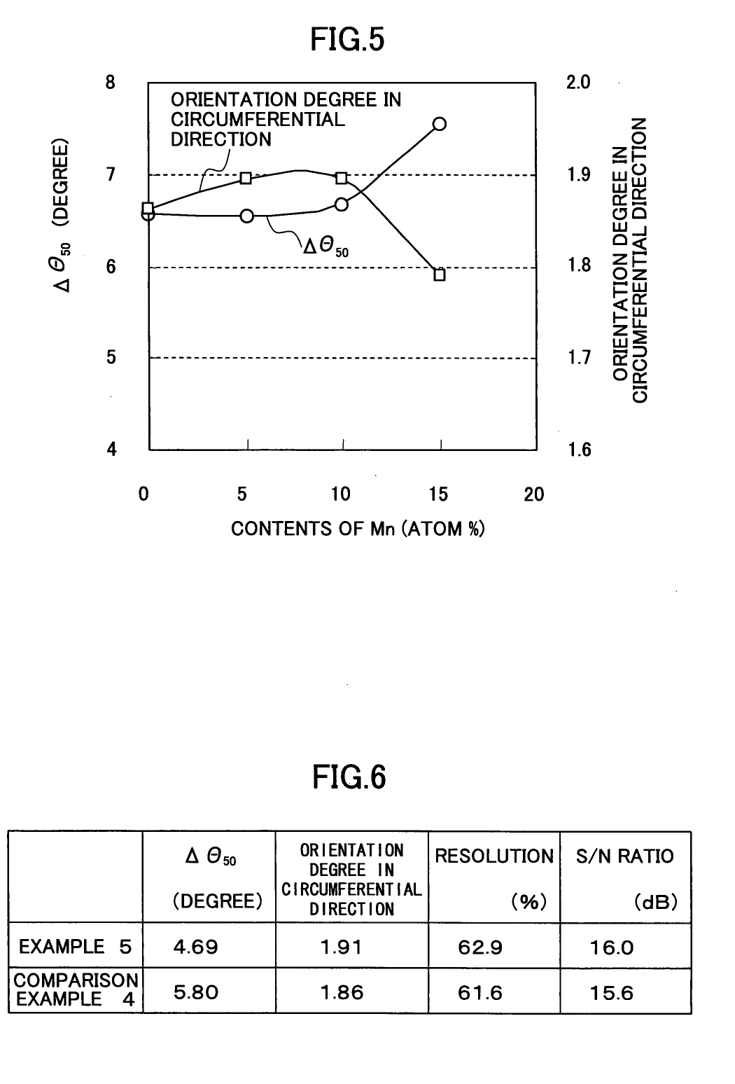

FIG. 4 is a graph showing characteristic properties of intra-surface orientation of a magnetic recording medium of the example 4. FIG. 5 is a graph showing characteristic properties of intra-surface orientation of a magnetic recording medium of the comparison example 3. Vertical axes of left sides of FIG. 4 and FIG. 5 indicate Δθ₅₀ and vertical axes of right sides of FIG. 4 and FIG. 5 indicate orientation degrees in the circumferential direction. Δθ₅₀ and orientation degrees are measured by the same conditions as those of the case shown in FIG. 2.

Referring to FIG. 5, in the comparison example 3, if the content of Mn is increased from 5 through 10 atom %, while the orientation degree in the circumferential direction is increased, Δθ₅₀ is almost not changed. If the content of Mn is increased from 15 atom %, the orientation degree and Δθ₅₀ are degraded.

Referring to FIG. 4, in the Example 4, by changing the content of Mn from 5 atom % to 0 atom %, Δθ₅₀ is drastically decreased and good. When the content of Mn is changed from 5 atom % to 20 atom %, Δθ₅₀ is substantially the same and smaller than that when the Mn is 0 atom %. On the other hand, the orientation degree in the circumferential direction is the substantially same regardless of the contents of Mn. Thus, it is found that, in the Example 4, the intra-surface orientation of the magnetic easy axis of the recording layer is improved when the content of Mn is greater than 0 atom % and equal to or less than 20 atom %. On the other hand, in a case where the first underlayer is omitted like the comparison example 3, since the intra-surface orientation is not improved, the intra-surface orientation of the magnetic easy axis of the recording layer is improved by a combination of the first underlayer and the second underlayer.

### EXAMPLE 5

A magnetic recording medium of the Example 5 has the same structure as that of the Example 1 other than that the first underlayer CrMn₅ film has film thickness of 1.5 nm and the second underlayer CrMn₁₀ film has film thickness of 2.5.

### COMPARISON EXAMPLE 4

In a magnetic recording medium of the comparison example 4, the same conditions are applied as the Example 5, other than that the film thickness of the first underlayer CrMn₅ film is 4 nm and the second underlayer is omitted.

FIG. 6 is a table showing characteristic properties of the example 5 and the comparison example 4. Δθ₅₀, orientation degrees, and the S/N ration shown in FIG. 6 are measured by the same conditions as those of the case shown in FIG. 2. In addition, resolution is obtained by using the device measuring the S/N ration and calculating “reproducing output of track recording density”÷“average output of track recording density”×100.

Referring to FIG. 6, in the Example 5 as compared with the comparison example 4, Δθ₅₀ indicating the intra-surface orientation, the orientation degree in the circumferential direction, the resolution, and the S/N ratio are improved. Thus, intra-surface orientation, the orientation degree in the circumferential direction, the resolution, and the S/N ratio in the case where two layers of the CrMn films are formed and content of Mn of the second underlayer is greater than that of the first underlayer are improved more that the case of a single CrMn₅ film.

### 2. A Second Embodiment of the Present Invention

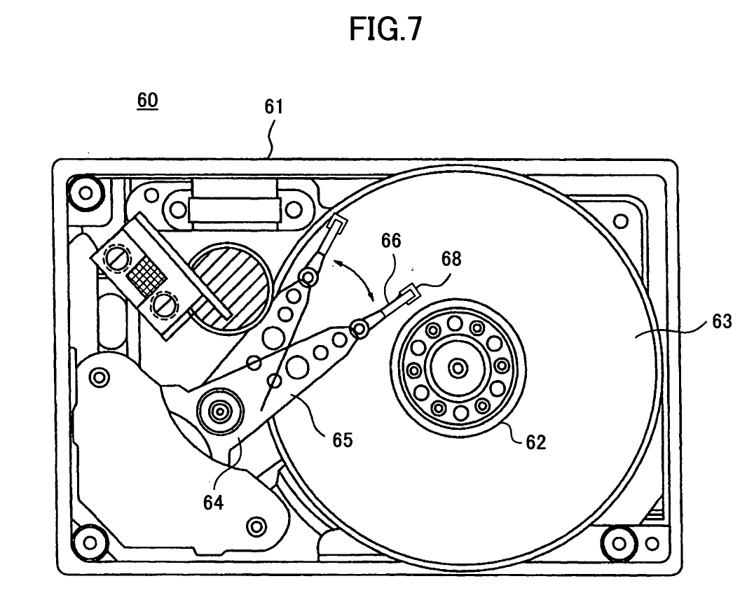

A magnetic storage device of the second embodiment of the present invention includes the magnetic recording medium of the first embodiment of the present invention. Here, FIG. 7 is a view showing a main part of the magnetic storage device of the second embodiment of the present invention.

Referring to FIG. 7, the magnetic storage device 60 includes a housing 61. In the housing 61, a hub 62, a magnetic recording medium 63, an actuator unit 64, an arm 65, a suspension 66, and a magnetic head 68. The hub 62 is driven by a spindle (not shown in FIG. 7). The magnetic recording medium 63 is fixed to the hub 62 and rotated. The arm is attached to the actuator unit 64 and moved in a radial direction of the magnetic recording medium 63. The magnetic head 68 is supported by the suspension 66. The magnetic head 68 is formed by a composite type head of a reproducing head and a recording head. The reproducing head is, for example, an MR (magneto resistance) type element, a GMR (giant magneto resistance) type element, or TMR (tunnel magneto resistance) type element. Since the basic structure of the magnetic storage device 60 is known, details thereof are omitted in this specification.

The magnetic recording medium 63 is the magnetic recording medium of the first embodiment of the present invention. In the magnetic recording medium 63, since the orientation in the intra-surface direction of the recording layer is good, the S/N ratio is good. Therefore, it is possible to achieve the high density recording with the magnetic storage device 60.

The basic structure of the magnetic storage device 60 of the second embodiment of the present invention is not limited to the structure shown in FIG. 7. The structure of the magnetic head 68 is not limited to the structure discussed above. A structure of any known magnetic head can be applied to the magnetic head 68.

The present invention is not limited to these embodiments, but variations and modifications may be made without departing from the scope of the present invention.

For example, although the magnetic disk is discussed as an example of the magnetic recording medium in the second embodiment of the present invention, a magnetic head can be used as the magnetic recording medium. In the magnetic tape, a tape substrate instead of the disk-shaped substrate, such as a tape plastic film made of PET (polyethylene-Terephthalate), PEN (Polyethylene naphtahalate), or polyimide, can be used.

This patent application is based on Japanese Priority Patent Application No. 2006-289146 filed on Oct. 24, 2006, the entire contents of which are hereby incorporated by reference.

What is claimed is:

1. A magnetic recording medium, comprising:
a substrate having a surface where a texture is formed along a recording direction;
a first underlayer formed on the surface of the substrate and made of Cr or CrMn;
a second underlayer formed on the first underlayer and made of CrMn;
a third underlayer formed on the second underlayer and made of Cr—X1 alloy wherein X1 includes a material selected from the group consisting of Mo, Ti, W, V, Ta, and Nb; and
a recording layer formed on the third underlayer and made of a ferromagnetic material whose main ingredient is Co;
wherein content of Mn of the second underlayer is greater than content of Mn of the first underlayer if the first underlayer is made of CrMn; and
a total of film thicknesses of the first underlayer and the second underlayer is in a range between 2 nm and 7 nm.

2. The magnetic recording medium as claimed in claim 1,
wherein the third underlayer further includes an additional element selected from the group consisting of B, C, and Zr.

3. The magnetic recording medium as claimed in claim 1, further comprising:
a fourth underlayer provided between the third underlayer and the recording layer and made of Cr—X1 alloy wherein X1 includes a material selected from the group consisting of Mo, Ti, W, V, Ta, and Nb; and
wherein the third underlayer or the fourth underlayer further includes an additional element selected from the group consisting of B, C, and Zr.

4. The magnetic recording medium as claimed in claim 3,
wherein content of the additional element is in a range equal to or greater than 1 atom % and equal to or less than 10 atom %.

5. The magnetic recording medium as claimed in claim 1,
wherein the third underlayer includes Mn instead of or in addition to X1 or the fourth underlayer additionally include Mn;
the third underlayer or the fourth underlayer includes an additional element;
content of Mn is equal to or less than 30 atom %; and
the additional element is selected from the group consisting of B, C, and Zr.

6. The magnetic recording medium as claimed in claim 1,
wherein the first underlayer is made of CrMn; and
content of Mn is equal to or less than 35 atom %.

7. The magnetic recording medium as claimed in claim 1,
wherein content of Mn of the second underlayer is equal to or less than 35 atom %.

8. The magnetic recording medium as claimed in claim 1, further comprising:
a nonmagnetic coupling layer coming in contact with a lower side of the recording layer; and
a heat stabilization layer coming in contact with the nonmagnetic coupling layer and made of a ferromagnetic material whose main ingredient is Co;
wherein antiferromagnetic exchange coupling of the heat stabilization film and the recording layer is made.

9. The magnetic recording medium as claimed in claim 8,
wherein the heat stabilization layer and the recording layer are made of CoCr or CoCr-M1 alloy;
M1 is a material selected from the group consisting of Pt, B, Ta, Ni, Cu, Ag, Pd, Si, C, Fe, Re, Nb, Hf, and an alloy of Pt, B, Ta, Ni, Cu, Ag, Pd, Si, C, Fe, Re, Nb, Hf; and an alloy of Pt, B, Ta, Ni, Cu, Ag, Pd, Si, C, Fe, Re, Nb, Hf; and
content of Co is equal to or greater than 50 atom %.

10. A magnetic storage device, comprising:
a magnetic recording medium; and
a recording and reproducing part having a recording element and a magneto-resistive effect type reproducing element;
wherein the recording medium, including:
a substrate having a surface where a texture is formed along a recording direction;
a first underlayer formed on the surface of the substrate and made of Cr or CrMn;
a second underlayer formed on the first underlayer and made of CrMn;
a third underlayer formed on the second underlayer and made of Cr—X1 alloy wherein X1 includes a material selected from the group consisting of Mo, Ti, W, V, Ta, and Nb; and
a recording layer formed on the third underlayer and made of a ferromagnetic material whose main ingredient is Co;
wherein content of Mn of the second underlayer is greater than content of Mn of the first underlayer if the first underlayer is made of CrMn; and
a total of film thicknesses of the first underlayer and the second underlayer is in a range between 2 nm and 7 nm.
